(19) United States
(12) Patent Application Publication
(10) Pub. No.: US 2024/0153065 A1
(43) Pub. Date: May 9, 2024

(54) LEARNING DEVICE, LEARNING METHOD, INSPECTION DEVICE, INSPECTION METHOD, AND RECORDING MEDIUM

(71) Applicant: NEC Corporation, Minato-ku, Tokyo (JP)

(72) Inventors: Shigeaki NAMIKI, Tokyo (JP); Takuya OGAWA, Tokyo (JP); Keiko INOUE, Tokyo (JP); Shoji YACHIDA, Tokyo (JP); Toshinori HOSOl, Tokyo (JP)

(73) Assignee: NEC Corporation, Minato-ku, Tokyo (JP)

(21) Appl. No.: 18/279,504

(22) PCT Filed: Mar. 4, 2021
(86) PCT No.: PCT/JP2021/008389

§ 371 Date: Aug. 30, 2023

(51) Int. Cl. G06T 7/00; G06V 10/44

(52) U.S. Cl. CPC G06T 7/0008; G06V 10/44; G06T 2207/20081; G06T 2207/20084

(57) ABSTRACT

In a learning device, an acquisition means acquires captured images in a time series which capture a target object. Next, a learning means simultaneously trains a group discrimination model for discriminating a plurality of groups from the captured images based on features in each image and a plurality of recognition models each for recognizing captured images belonging to a corresponding group.

### TECHNICAL FIELD

The present disclosure relates to an inspection method of a target object using an image.

### BACKGROUND ART

A technique for carrying out an inspection for an abnormality using an image of a product has been proposed. For example, Patent Document 1 discloses an appearance inspection device which captures an image of a tablet as the product to be inspected in three directions, and performs a shape inspection, a color inspection, and a crack inspection on the image in the three directions to determine whether the tablet is qualified or not.

### PRECEDING TECHNICAL REFERENCES

### Patent Document

Patent Document 1: Japanese Laid-open Patent Publication No. 2005-172608

### SUMMARY

### Problem to be Solved by the Invention

In an appearance inspection device of Patent Document 1, the same inspection is performed in three directions with respect to an image of an object to be inspected. However, in reality, anomalies tend to vary from surface to surface or part to part of each product to be inspected.

It is one object of the present disclosure to provide an inspection device capable of performing an abnormality determination in an image recognition method suitable for each plane or each portion of a product to be inspected.

### Means for Solving the Problem

According to an example aspect of the present disclosure, there is provided a learning device including:
an acquisition means configured to acquire captured images in a time series which capture a target object; and
a learning means configured to simultaneously train a group discrimination model for discriminating a plurality of groups from the captured images based on features in each image and the plurality of recognition models each for recognizing captured images belonging to a corresponding group.

According to another example aspect of the present disclosure, there is
provided a learning method including:
acquiring captured images in a time series which capture a target object; and simultaneously training a group discrimination model for discriminating a plurality of groups from the captured images based on features in each image and the plurality of recognition models each for recognizing captured images belonging to a corresponding group.

According to a further example aspect of the present disclosure, there is provided a recording medium storing a program, the program causing a computer to perform a process including:
acquiring captured images in a time series which capture a target object; and
simultaneously training a group discrimination model for discriminating a plurality of groups from the captured images based on features in each image and the plurality of recognition models each for recognizing captured images belonging to a corresponding group.

According to a further example aspect of the present disclosure, there is provided an inspection device including:
an acquisition means configured to acquire captured images in a time series which capture a target object;
a group discrimination means configured to discriminate a plurality of groups from the captured images based on features in each image;
a recognition means configured to recognize the captured images belonging to each of the groups and determine an abnormality of the target object, by using the plurality of recognition models; and
an integration means configured to integrate determination results of the plurality of recognition models and output a final determination result,
wherein the group discrimination model and the plurality recognition models are simultaneously trained.

According to a still further example aspect of the present disclosure, there is provided an inspection method including:
acquiring captured images in a time series which capture a target object;
discriminating a plurality of groups from the captured images based on features in each image;
recognizing the captured images belonging to each of the groups and determining an abnormality of the target object, by using the plurality of recognition models; and
integrating determination results of the plurality of recognition models and outputting a final determination result,
wherein the group discrimination model and the plurality recognition models are simultaneously trained.

According to a yet still example aspect of the present disclosure, there is provided a recording medium storing a program, the program causing a computer to perform a process including:
acquiring captured images in a time series which capture a target object;
discriminating a plurality of groups from the captured images based on features in each image;
recognizing the captured images belonging to each of the groups and determining an abnormality of the target object, by using the plurality of recognition models; and
integrating determination results of the plurality of recognition models and outputting a final determination result,
wherein the group discrimination model and the plurality recognition models are simultaneously trained.

### Effect of the Invention

According to the present disclosure, it becomes possible to perform an abnormality determination in an image recognition method suitable for each plane or each portion of an inspection object.

### BRIEF DESCRIPTION OF THE DRAWINGS

FIG. 1A to FIG. 1C illustrate an inspection using an inspection device.

FIG. 2 illustrates a hardware configuration of an inspection device according to a first example embodiment.

FIG. 3 illustrates a functional configuration of the inspection device according to the first example embodiment.

FIG. 4 illustrates a configuration for acquiring a target object image sequence.

FIG. 5 is a diagram for explaining a learning method for a group discrimination unit and a recognizer.

FIG. 6 illustrates a configuration for learning the group discrimination unit and the recognizer.

FIG. 7 is a flowchart of a learning process of the group discrimination unit and the recognizer.

FIG. 8 illustrates a configuration at the inspection (at an inference) by the inspection device.

FIG. 9 is a flowchart of an inspection process by the inspection device.

FIG. 10 illustrates a functional configuration of an inspection device according to a second example embodiment.

FIG. 11 schematically illustrates a configuration of a neural network.

FIG. 12 illustrates a configuration of the neural network at a learning.

FIG. 13 is a flowchart of a learning process of the neural network.

FIG. 14 illustrates a configuration of the inspection device at an inspection.

FIG. 15 is a flowchart of an inspection process by the inspection device.

FIG. 16 illustrates a functional configuration of a learning device according to a third example embodiment.

FIG. 17 is a flowchart of a process by a learning device according to the third example embodiment.

FIG. 18 illustrates a functional configuration of an inspection device according to a fourth example embodiment.

FIG. 19 is a flowchart of a process by the inspection device the fourth example embodiment.

### EXAMPLE EMBODIMENTS

In the following, example embodiments will be described with reference to the accompanying drawings.

### First Example Embodiment

[Overview of Inspection]

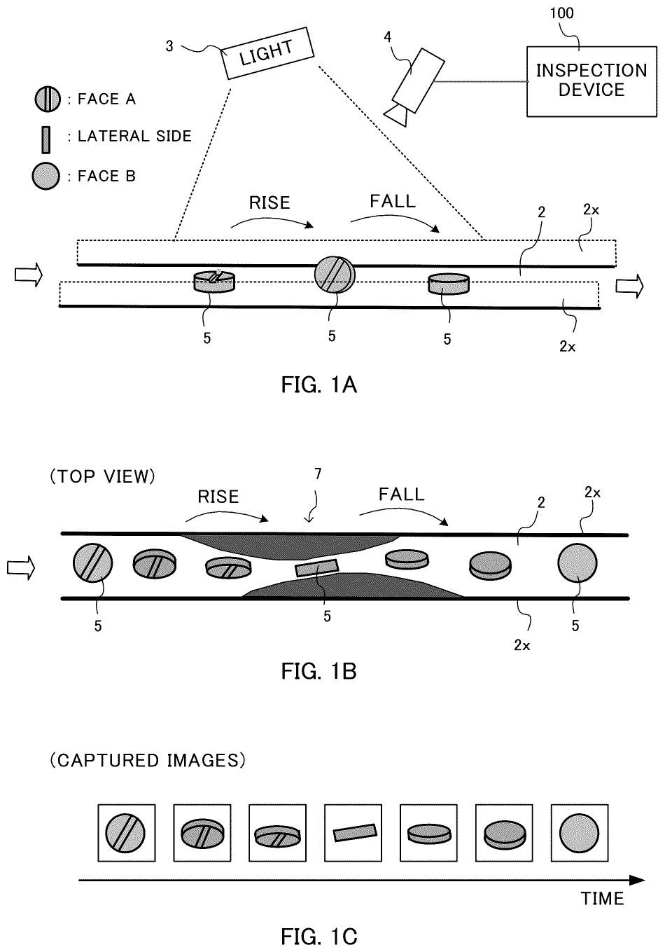

First, an overview of inspection by an inspection device 100 according to the present disclosure will be described. FIG. 1A illustrates a state of an inspection using the inspection device 100. In the present example embodiment, an object to be inspected is a tablet 5. The tablet 5 moves in a direction of an arrow on a rail 2 by fanning the air in the direction of an arrow. Note that for convenience of illustration, a lateral wall 2x of the rail 2 is illustrated as a dashed line in FIG. 1A.

A light 3 and a high-speed camera 4 are disposed above the rail 2. Depending on a shape of the object and a type of an abnormality to be detected, a plurality of lights in various intensities and lighting ranges are installed. Especially in a case of a small object such as the tablet 5, since a type, a degree, a position, and the like of several lights may be used to capture images under various lighting conditions.

The high-speed camera 4 captures images of the tablet 5 under illumination at high speed and outputs captured images to the inspection device 100. In a case where each image is taken by the high-speed camera 4 while moving the tablet 5, it is possible to capture images of a minute abnormality which exists on the tablet 5 without missing that abnormality. Specifically, the abnormality which occurs on the tablet may be adhesion of a hair, a minute crack, or the like.

The tablet 5 is reversed by a reversing mechanism provided on the rail 2. In FIG. 1A, the reversing mechanism is omitted for convenience, and only the behavior of the tablets on rail 2 is illustrated. Hereinafter, for convenience of explanation, a side of the tablet 5 with a split line is referred to as a “face A,” a side without the split line as a “face B,” and a face of the tablet 5 from a side view is referred to as a “lateral side”. Note that the “split line” refers to a cut or indentation made in one side of the tablet in order to split the tablet in half.

FIG. 1B schematically illustrates the reversing mechanism provided on the rail 2. As illustrated, on an inner side of the lateral wall 2x of the rail 2, there is a narrowing section 7 which narrows the width of the rail 2 as the reversing mechanism. The narrowing section 7 is formed so that the lateral wall 2x of the rail 2 extends inward. The tablet 5 basically moves in a falling down state in an area other than the narrowing section 7, but rises up when passing through the narrowing section 7 and falls down on an opposite side after passing through the narrowing section 7. Accordingly, the tablet 5 is reversed on the rail 2.

FIG. 1C illustrates an example of the captured images by the high-speed camera 4 (hereinafter, simply referred to as the “camera 4”). Incidentally, FIG. 1C is an image acquired by extracting only the region of the tablet 5 which is a target object from among the captured images by the camera 4, and corresponds to a target object image sequence to be described later. The tablet 5 is set so that the face A is on the top and moves in the direction of the arrow on the rail 2 from the left side in FIG. 1B, while the camera 4 takes images of the face A of the tablet 5. After that, the tablet 5 rises in the narrowing section 7, and at that time the camera 4 takes images of the lateral side of the tablet 5. When passing through the narrowing section 7, the tablet 5 falls to an opposite side, and the camera 4 then captures images of the face B of the tablet 5. Thus, as illustrated in FIG. 1C, temporal images including the face A, the lateral side, and the face B of the tablet (hereinafter, also referred to as an “image sequence”.) is acquired. Note that since the tablet 5 is fed by the air, the tablet 5 rises in the narrowing section 7 and moves on the rail 2 while rotating in a circumferential direction. Therefore, it is possible for the camera 4 to capture the entire circumference of the lateral side of the tablet 5. Accordingly, it is possible to capture every side of the tablet 5.

[Hardware Configuration]

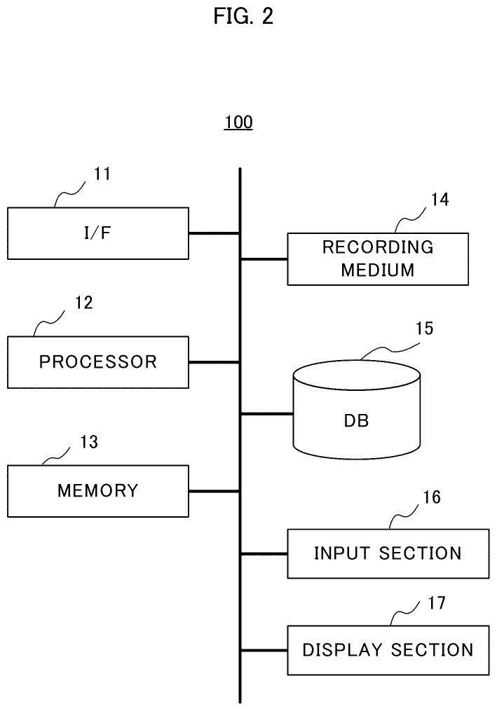

FIG. 2 is a block diagram illustrating a hardware configuration of the inspection device 100 according to the first example embodiment. As illustrated, the inspection device 100 includes an interface (I/F) 11, a processor 12, a memory 13, a recording medium 14, a database (DB) 15, an input section 16, and a display section 17.

The interface 11 inputs and outputs data to and from an external device. Specifically, the image sequence (temporal images) of the tablet captured by the camera 4 is input through the interface 11. Also, a determination result of the abnormality generated by the inspection device 100 is output to the external device through the interface 11.

The processor 12 corresponds to one or more processors each being a computer such as a CPU (Central Processing Unit) and controls the entire inspection device 100 by executing programs prepared in advance. The processor 12 may be a GPU (Graphics Processing Unit) or a FPGA (Field-Programmable Gate Array). The processor 12 executes an inspection process to be described later.

The memory 13 is formed by a ROM (Read Only Memory), a RAM (Random Access Memory), and the like. The memory 13 is also used as a working memory during executions of various processes by the processor 12.

The recording medium 14 is a non-volatile and non-transitory recording medium such as a disk-shaped recording medium or a semiconductor memory and is formed to be detachable with respect to the inspection device 100. The recording medium 14 records various programs executed by the processor 12. When the inspection device 100 performs the various processes, the programs recorded on the recording medium 14 are loaded into the memory 13 and executed by the processor 12.

The DB 15 stores the image sequence input from the camera 4 as needed. The input section 16 includes a keyboard, a mouse, and the like for a user to perform instructions and input. The display section 17 is formed by, for instance, a liquid crystal display, and displays a recognition result of the target object.

[Functional Configuration]

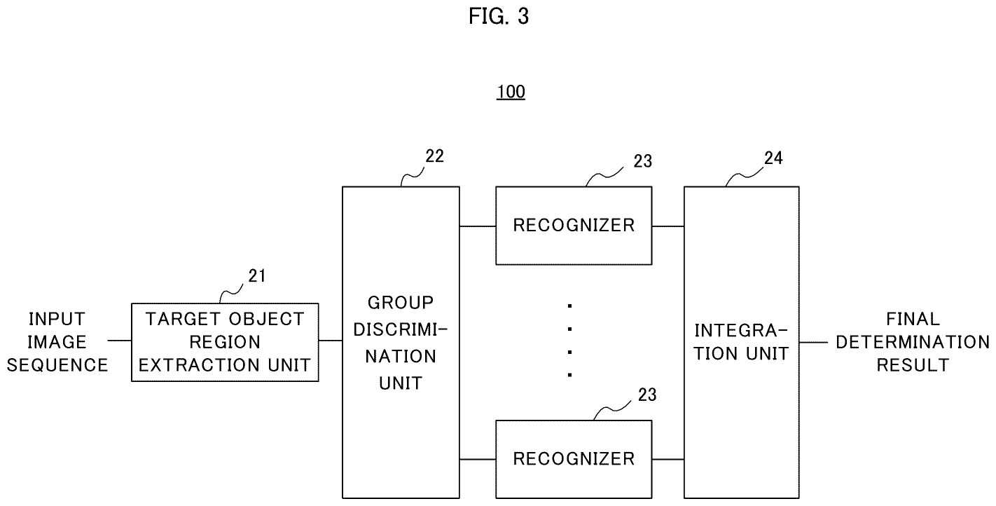

FIG. 3 is a block diagram illustrating a functional configuration of the inspection device 100 according to the first example embodiment. The inspection device 100 determines the abnormality of the tablet 5 based on a sequence of images input from the camera 4 (hereinafter, referred to as an “input image sequence”), and outputs the determination result. As illustrated, the inspection device 100 includes a target object region extraction unit 21, a group discrimination unit 22, a plurality of recognizers, and an integration unit 24.

The target object region extraction unit 21 extracts a region of the tablet 5 which is a target object to be inspected from the input image sequence, and outputs an image sequence (hereinafter, referred to as the “target object image sequence”) indicating the region of the target object. The target object image sequence corresponds to a set of images in which only a portion of the target object is extracted from the images captured by the camera 4 as illustrated in FIG. 1C.

The group discrimination unit 22 uses a group discrimination model to classify a plurality of frame images forming the target object image sequence. The group discrimination unit 22 outputs the image sequence of each group acquired by the classification to a corresponding recognizer 23. Each of the recognizers 23 uses the recognition model to perform an image recognition with respect to the image sequence of each group, and determines whether or not an abnormality exists. Each of the recognizers 23 outputs the determination result to the integration unit 24. Note that the group discrimination model used by the group discrimination unit 22 and the learning of the recognition model used by the recognizer 23 will be described later.

The integration unit 24 generates a final determination result of the tablet 5 based on the determination result output by the plurality of recognizers 23. For instance, in a case where each of the recognizers 23 performs a binary decision (0: normal, 1: abnormal) for a normality or the abnormality of the tablet 5, the integration unit 24 uses a max function, and decides the final determination result so as to indicate the abnormality when even one of the determination results of the three groups indicates the abnormality. Moreover, in a case where each of the recognizers 23 outputs a degree of abnormality for the tablet 5 in a range of “0” to “1”, the integration unit 24 outputs the degree of abnormality for an image having the highest degree of abnormality by using the max function as the final determination result.

In the above-described configuration, the target object region extraction unit 21 corresponds to an example of an acquisition means, the group discrimination unit 22 corresponds to an example of a group discrimination means, the recognizers 23 correspond to an example of a recognition means, and the integration unit 24 corresponds to an example of an integration means.

[Process of Each Part]

(Acquisition of Target Object Image Sequence)

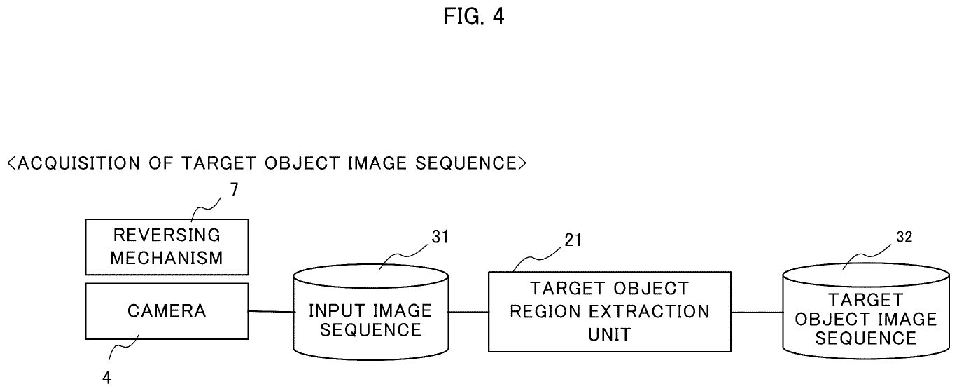

FIG. 4 illustrates a configuration for acquiring the target object image sequence. An input image sequence 31 is acquired by reversing the tablet 5 which is the target object by the reversing mechanism 7 within an angle of view of the camera 4 and capturing the aspect with the camera 4. The target object region extraction unit 21 outputs a target object image sequence 32 indicating a portion of the target object 5 from the input image sequence 31. Accordingly, the target object image sequence as depicted in FIG. 1C is acquired.

(Learning of Group Discrimination Unit and Recognizer)

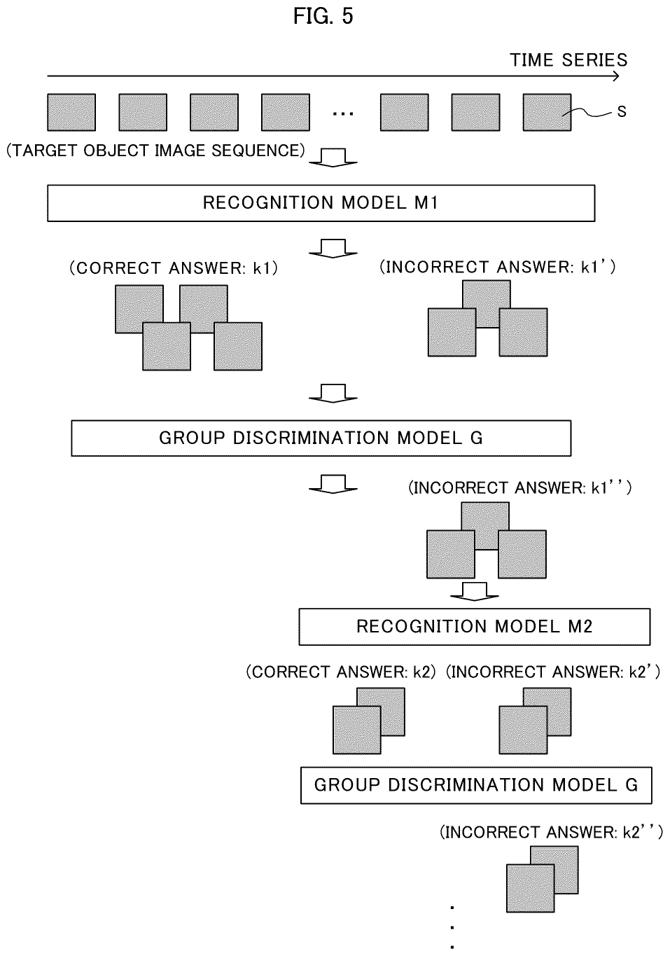

FIG. 5 is a diagram illustrating a learning method of the group discrimination unit 22 and the recognizers 23. In the present example embodiment, the group discrimination unit 22 and the recognizers 23 are learned simultaneously, that is, in parallel in time. In detail, training for the recognition model by the recognizer 23 and training for the group discrimination model by the group discrimination unit 22 are alternately repeated to generate the number of necessary recognition models. More specifically, the recognizer 23 is learned first, and then a learning process of the group discrimination unit 22 is a single loop process, and a loop process is repeated until a predetermined end condition is provided. Hereinafter, an iteration number for the above loop process is indicated by “k”. In addition, it is assumed that the number of recognizers 23 (recognition models) is indicated by “N”, and the number of recognition models is indicated by N=1 at a beginning of the learning process.

In FIG. 5, each of frame images included in the target object image sequence 32 input from the target object region extraction unit 21 are referred to as “sample S”. Each sample S is acquired by capturing one tablet 5. At the learning, for each sample S, an input label (correct answer label) indicating whether or not the sample includes an abnormality of the target object is prepared in advance.

As illustrated in FIG. 5, first, in the loop process of a first time (k=1), one recognition model M1 is trained using all samples S of the target object image sequence. During training, the recognition model M1 is trained by comparing inference results with input labels prepared in advance. When the training is completed, all samples S are input into the trained recognition model M1 to perform the inference, and it is determined whether or not the trained recognition model M1 correctly determines the abnormality. Thus, all samples S are classified into a sample group (hereinafter, also referred to as a “correct answer sample group”) k1 in which the recognition model M1 is correct and a sample group (hereinafter, also referred to as an “incorrect answer sample group”) k1′ in which the recognition model M1 is wrong. Here, the sample group M1 in which the recognition model M1 is correct is considered to be a sample group in which an abnormality determination is correctly performed by the recognition model M1. In contrast, the incorrect answer sample group k1′, in which the recognition model M1 is incorrect, is considered to be a sample for which it is difficult for the recognition model M1 to correctly determine the abnormality. In other words, only one recognition model M1 is insufficient to correctly perform the abnormality determination with respect to each of all samples S, and at least one more recognition model is needed for the sample group k1′ for which the recognition model M1 is incorrect. That is, the number of necessary recognition models is N=2.

Thus, since the need for two recognition models arises, a group discrimination model G is trained to classify all samples S into two groups. In detail, the group discrimination model G is trained using the correct answer sample group k1 and the incorrect answer sample group k1′. When the training of the group discrimination model G is completed, all samples S are input into the acquired group discrimination model G, and the incorrect answer sample group k1″ is acquired. Since the aforementioned incorrect answer sample group k1′ is a result by the recognition model M1 and does not necessarily match with the discrimination result by the group discrimination model G, the incorrect answer sample group acquired by the group discrimination model G is distinguished as k1″.

Accordingly, since the group discrimination model G which classifies all samples S into two groups has been acquire, next, a second recognition model is generated. In detail, the incorrect answer sample group k1″ is used to train a recognition model M2 different from the recognition model M1. Then, the inference is performed by inputting the incorrect answer sample group k1 for the acquired recognition model M2, to acquire the correct answer sample group k2 by the recognition model M2 and the incorrect answer sample group k2′.

Here, the incorrect answer sample group k2′ is a sample group for which it is difficult to correctly determine the abnormality depending on the added recognition model M2. In other words, the recognition models M1 and M2 are not sufficient to correctly determine all samples S, and additional recognition models are needed. Therefore, next, the number of necessary recognition models is further increased by one to be N=3, and the group discrimination model G is trained to classify all samples S into three groups.

Thus, the above-described loop process is repeated until any of the following end conditions is provided, and the group discrimination model is updated and the recognition model is added.
(a) The above looping process reaches a predetermined number of times (k=kmax).
(b) The recognition model achieves a certain accuracy and the number of incorrect answer sample groups is sufficiently reduced.
(c) An improvement range of accuracy of the recognition model falls less than a threshold value (that is, the accuracy does not improve any further).

Accordingly, it becomes possible to perform the abnormality determination using an appropriate number of the recognizers 23 in accordance with the target object image sequence generated by capturing.

Note that a method for updating the group discrimination model G as the number of recognition models increases depends on a type of the group identification model G. For instance, in a case where a k-means or a SVM (Support Vector Machine) is used as the group discrimination model G, a model is added for updating. In addition, in a case where a Kdtree is used as the group discrimination model G, the number of groups is increased for a re-learning.

In actual training, the number of samples belonging to the incorrect answer sample group decreases as the above loop process is repeated. Therefore, in order to train the group discrimination model and the recognition model to be added, it is necessary to secure a data number to be used for training by a data augmentation. Moreover, the iterations of the loop process cause an imbalance in the number of data in the correct and incorrect answer sample groups, it is desirable to eliminate the imbalance by oversampling or undersampling as necessary.

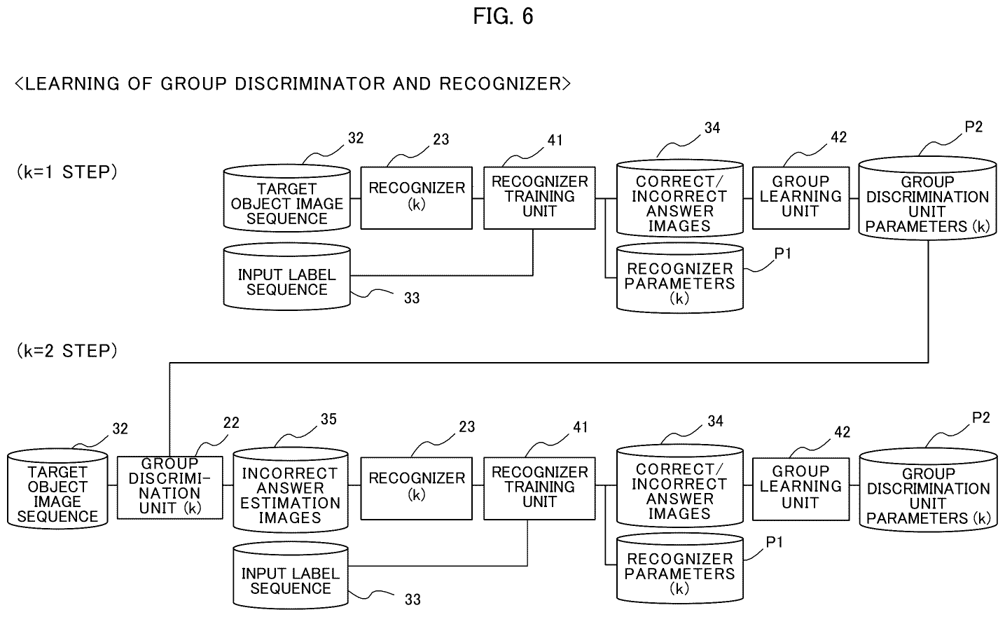

FIG. 6 illustrates a configuration for learning of the group discrimination unit 22 and each of the recognizers 23. First, in a first step of the loop process (k=1), the target object image sequence 32 generated by the target object region extraction unit 21 is input to the k(=1)th recognizer 23. A recognizer learning unit 41 trains the first recognizer 23 using the target object image sequence 32 and an input label sequence 33, and generates recognizer parameters P1 corresponding to the first recognizer 23. Moreover, the target object image sequence 32 is input to the first recognizer 23 acquired by training, and the inference is performed, correct/incorrect answer images 34 are acquired. Correct images correspond to the aforementioned correct answer sample group k1, and incorrect answer images correspond to the aforementioned incorrect answer sample group k1′.

When the incorrect answer images are acquired, a group learning unit 42 trains the group discrimination model so as to increment the iteration number k of the loop process by one (k=k+1) and performs the classification into k(=2) groups, and generates the group discrimination unit parameters P2.

In the second step of the loop process (k=2), the group discrimination unit parameters P2 acquired in the first step is set to the group discrimination unit 22. The group discrimination unit 22 performs the inference of dividing the target object image sequence 32 into two groups. Accordingly, incorrect answer estimation images 35 (corresponding to the aforementioned incorrect answer sample group k1) are acquired. The recognizer learning unit 41 trains the second recognizer 23 using the incorrect answer estimation images 35 and the input label sequence 33, and generates the recognizer parameters P1 corresponding to the second recognizer 23. Moreover, the target object image sequence 32 is input to the second recognizer 23 acquired by training to perform the inference, the correct/incorrect answer images 34 are acquired. The correct answer images correspond to the aforementioned correct answer sample group k2, and the incorrect answer image correspond to the aforementioned incorrect answer sample group k2′.

When incorrect answer images are acquired, the group learning unit 42 further increments the iteration number k of the loop process by one, and trains the group discrimination model so as to perform grouping into k (=3) groups, and generates the group discrimination unit parameters P2. Next, in the same manner as in the second step, a process of a third step (k=3) is executed. Accordingly, the loop process is iteratively executed until the aforementioned end condition is satisfied, and the recognition model and group recognition model are obtained based on the recognizer parameters P1 and the group discrimination unit parameters P2 at the end of the process.

In the above-described configuration, the target object region extraction unit 21 corresponds to an example of an acquisition means, and the recognizer learning unit 41 and the group learning unit 42 correspond to an example of a learning means.

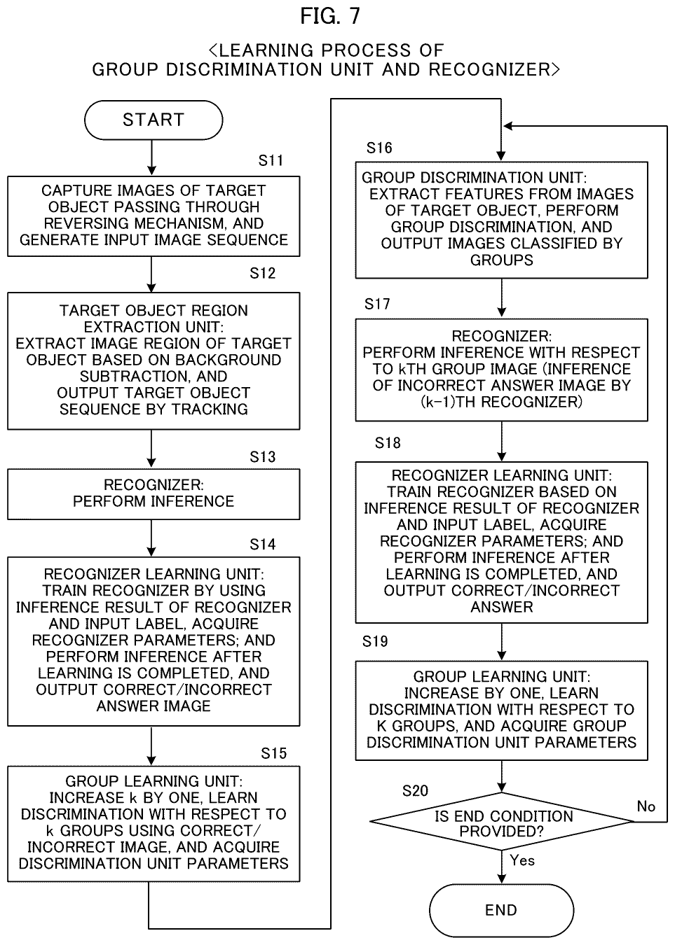

FIG. 7 is a flowchart of the learning process of the group discrimination unit and the recognizer. This process is realized by executing a program prepared in advance by the processor 12 described in FIG. 2. First, the target object passing through the reversing mechanism is captured by the camera 4, and the input image sequence 31 is generated (step S11). Next, the target object region extraction unit 21 extracts an image region of the target object from the input image sequence 31 using the background subtraction or the like, and outputs the target object image sequence 32 by tracking (step S12).

Next, the k(=1)th recognizer 23 performs the inference of the target object image sequence 32 (step S13). The recognizer learning unit 41 trains the k-th recognizer 23 by the inference result of the k-th recognizer 23 and the input label, and acquires the recognizer parameters P1. Moreover, the recognizer learning unit 41 performs the inference of the target object image sequence 32 by the recognizer 23 after the training, and outputs the correct/incorrect answer images 34 (step S14).

Next, the group learning unit 42 increments the iteration number k by 1 (k=k+1), trains the group discrimination model so as to discriminate k groups using the correct/incorrect answer images 34, and acquires the group discrimination unit parameters P2 (step S15).

Next, the group discrimination unit 22 extracts the features from the target object image sequence 32, performs a group discrimination, and outputs images classified into the k groups (step S16). Next, the k-th recognizer 23 performs the inference with respect to the k-th group image (that is, the image estimated as the incorrect answer image of the (k−1)th recognizer 23) (step S17). Next, the recognizer learning unit 41 trains the k-th recognizer 23 by the inference result of the k-th recognizer 23 and the input label, and acquires the recognizer parameters P1. The recognizer learning unit 41 performs the inference of the target object image sequence 32 by the kth recognizer 23 after the learning, and outputs the correct/incorrect answer images 34 (step S18).

Next, the group learning unit 42 increments k by 1 (k=k+1) using the correct/incorrect answer images 34 to train the group discrimination model so as to discriminate the k groups, to acquire the group discrimination unit parameters P2 (step S19).

Next, it is determined whether or not the above-described end condition is provided (step S20), and when the end condition is not satisfied (step S20: No), the learning process goes back to the step S16. On the other hand, when the end condition is satisfied (step S20: Yes), the learning process is terminated.

(At Inspection (at Inference))

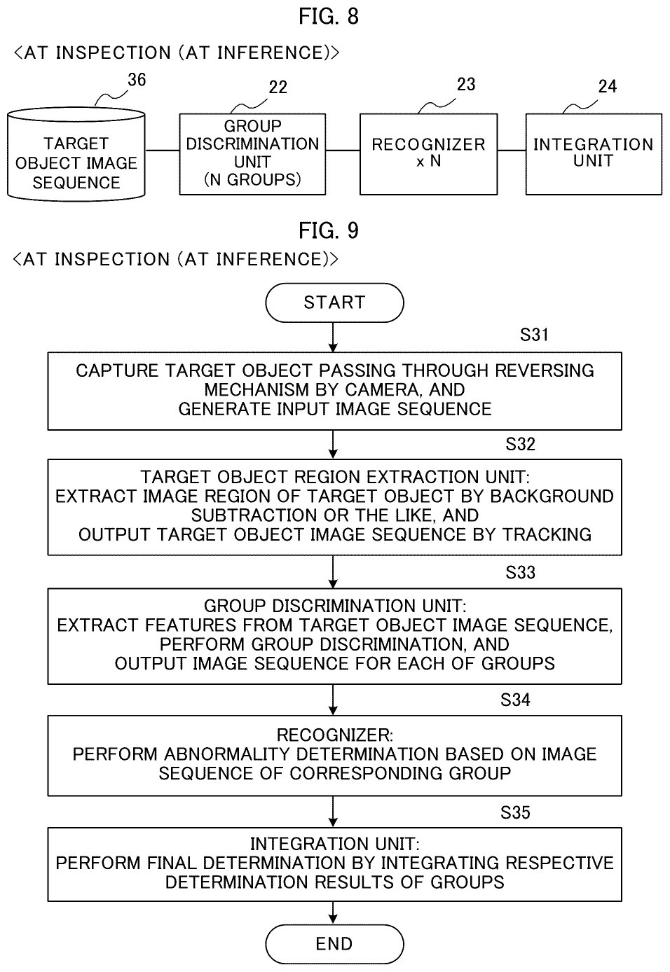

FIG. 8 illustrates a configuration at the inspection (at the inference) by the inspection device 100. At the inspection, a target object image sequence 36 acquired by capturing an actual inspection object is input. In addition, the group discrimination unit 22 is set with the group discrimination unit parameters P2 acquired by the above-described learning process, and divides the target object image sequence 36 by a number determined by the learning process. Moreover, the recognizer parameters P1 acquired by the above-described learning are set to the recognizers 23 corresponding to a number which has been determined by the above-described learning process. In the following description, it is assumed that the group discrimination unit 22 divides the target object image sequence 36 into N groups and the determination of abnormality is performed by N recognizers 23.

The target object region extraction unit 21 generates the target object image sequence 36 based on the input image sequence, and outputs the target object image sequence 36 to the group discrimination unit 22. The group discrimination unit 22 classifies images of the target object image sequence 36 into N groups, and outputs the classified images to the N recognizers 23. The N recognizer 23 determines a presence or absence of abnormality in each input image, and outputs the determination result to the integration unit 24. The integration unit 24 integrates the input determination result and outputs the final determination result.

FIG. 9 is a flowchart of the inspection process by the inspection device 100. This process is realized by executing a program prepared in advance by the processor 12 depicted in FIG. 2. First, the target object passing through the reversing mechanism is captured by the camera 4, and the input image sequence is generated (step S31). This input image sequence corresponds to images acquired by capturing the actual inspection object. Next, the target object region extraction unit 21 extracts the image region of the target object from the input image sequence by using the background subtraction or the like, and outputs the target object image sequence 36 by tracing the target object (step S32).

Next, the group discrimination unit 22 extracts the features from the target object image sequence 36, and performs the discrimination for the N groups, and outputs the image sequence for each of the N groups (step S33). Subsequence, the N respectively recognizers perform the abnormality determination based on the image sequences of the corresponding groups (step S34). After that, the integration unit 24 performs a final determination by integrating respective determination results of the recognizers 23 for each group (step S35). Accordingly, the inspection process is terminated.

Note that the group discrimination unit 22 classifies the images of the target object image sequence into a plurality of groups; however, with respect to a case where a group to which not even one captured image belongs exists among the plurality of groups, the inspection device 100 may determine that the inspection is insufficient, and may output that determination as the final determination result.

As described above, according to the first example embodiment, the training of each recognition model of the recognizers 23 and the training of the group discrimination model of the group discrimination unit 22 are alternately repeated to generate a necessary number of recognition models and the group discrimination model for classifying the images of the image sequence into the necessary number of groups. Therefore, it is possible to improve accuracy of the abnormality determination using an appropriate number of recognizers.

### Second Example Embodiment

Next, a second example embodiment will be described. In the second example embodiment, each of a group discrimination unit and recognizers is formed by a neural network (NN: Neural Network) to perform learning of an end-to-end (End to End). Accordingly, the group discrimination unit and the recognizers form a single unit, and the learning is performed consistently.

[Hardware Configuration]

A hardware configuration of an inspection device 200 of the second example embodiment is the same as that of the first example embodiment, and explanations thereof will be omitted.

[Functional Configuration]

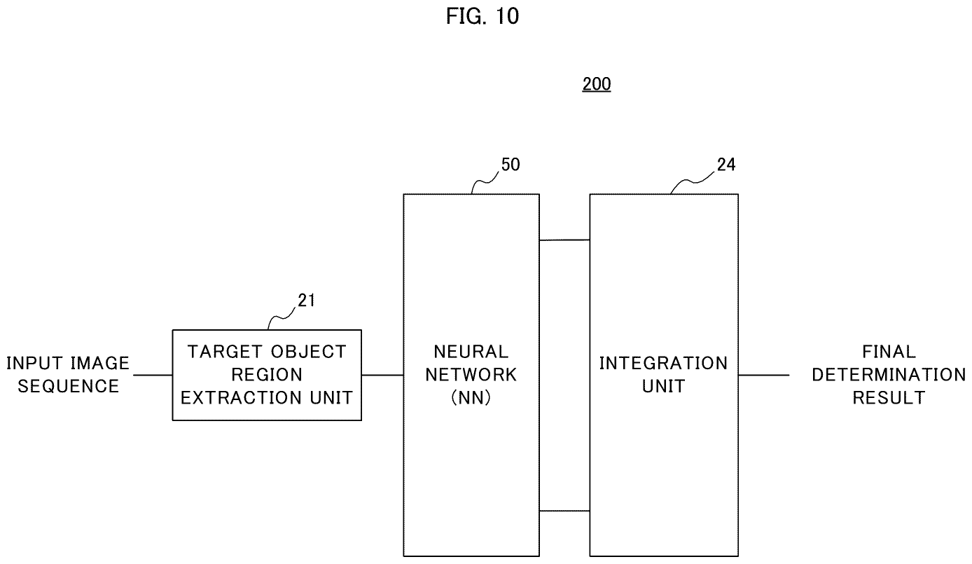

FIG. 10 illustrates a functional configuration of the inspection device 200 of the second example embodiment. As illustrated, in the second example embodiment, the inspection device 200 includes a target object region extraction unit 21, a neural network (NN) 50, and an integration unit 24. The target object region extraction unit 21 and the integration unit 24 are the same as those of the inspection device 100 of the first example embodiment.

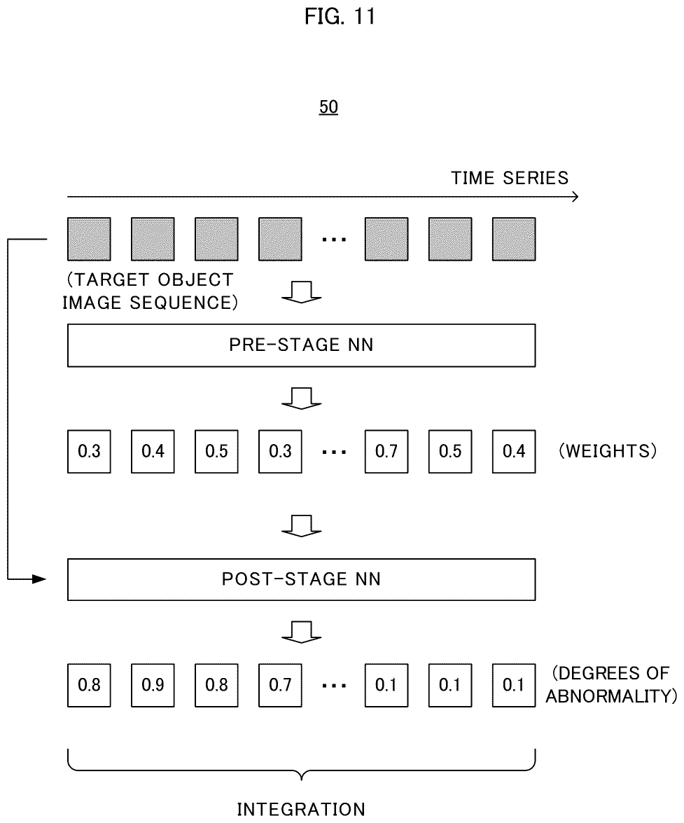

FIG. 11 schematically illustrates a configuration of the NN 50. The NN 50 includes a pre-stage NN and a post-stage NN. The target object image sequence is input to the first NN. The first NN corresponds to the group discrimination unit, and has a relatively lightweight structure. The first NN outputs corresponding weights by an image unit based on the input target object image sequence. These weights are calculated based on the features for each of the images included in the target object image sequence, and the same weight is assigned to the image having similar image features. Therefore, it is possible to consider these weights as a result of discriminating each of the images by the image features. The pre-stage NN may be formed to output the weights by a pixel unit. Each of the weights indicates a value between “0” and “1”. The weight output by the pre-stage NN is input into the post-stage NN.

The target object images are also input to the post-stage NN. The post-stage NN corresponds to a recognizer which performs the abnormality determination, and has a relatively heavy structure. The post-stage NN extracts the features of each of the images from the input target object image sequence, performs the abnormality determination, and outputs degrees of abnormality. The degrees of abnormality output by the post-stage NN are integrated by the integration unit 24, and the integrated degree is output as the final determination result.

As the post-stage NN, for instance, a CNN (Convolutional Neural Network) or a RNN (Recurrent Neural Network) can be used. In a case where the post-stage NN is the CNN, the weights output by the front NN are multiplied by a lost value calculated by the image unit to perfume the learning. In a case where the post-stage NN is the RNN, the weights output by the pre-stage NN are multiplied by temporal features to perform the learning. In a case where the pre-stage NN outputs the weights by the pixel unit, the post-stage NN may be designed to further multiply the feature map (feature map) of an intermediate layer by the weights. In this case, it is necessary to re-size the weights output by the pre-stage NN in accordance with a size of the feature map.

As described above, the NN is formed by the pre-stage NN and the post-stage NN, and by simultaneously and consistently training the pre-stage NN and the post-stage NN, the weighting of the pre-stage NN is learned so as to increase a recognition accuracy of the post-stage NN. At that time, it is expected to increase a weight for an image which is difficult to recognize and improve a recognition ability of that image which is difficult to recognize.

In the second example embodiment, the post-stage NN corresponding to the recognizer is regarded as a single NN; however, different parameter sets for the post-stage NN are functionally used as a plurality of recognition models by using the weighting as a machine learning-based attention (Attention).

[At Learning]

(Configuration at Learning)

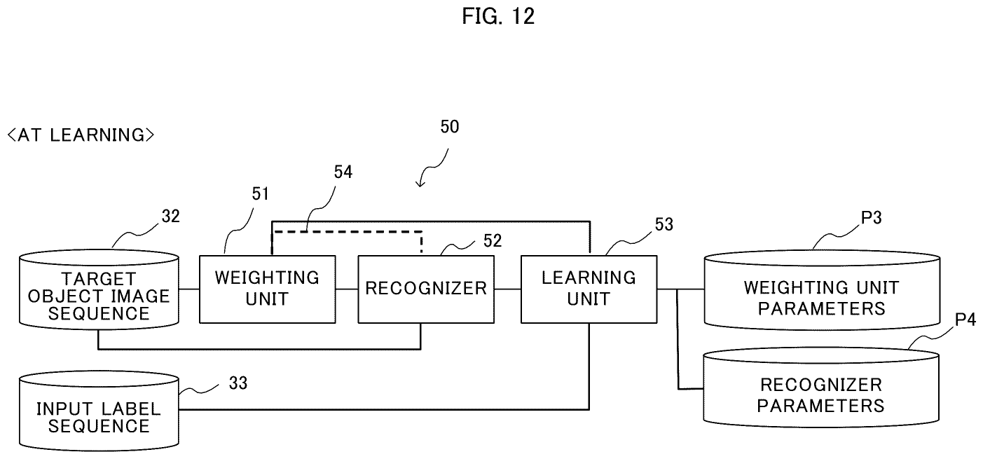

FIG. 12 illustrates a configuration at the learning of the NN 50. The NN 50 includes a weighting unit 51, a recognizer 52, and a learning unit 53. The weighting unit 51 is formed by the pre-stage NN, the recognizer 52 is formed by the post-stage NN. The weighting unit 51 generates weights for each image of the target object image sequence 32, and outputs the weights to the recognizer 52. The weighting unit may output the weights by the pixel unit as described above. A dashed line 54 in FIG. 12 indicates that the weights are input into the recognizer 52 in a case where the recognizer 52 is the RNN.

The recognizer 52 performs the abnormality determination by extracting the features of the target object image sequence 32 based on the weights output by the weighting unit 51, and outputs the degree of abnormality. The learning unit 53 performs the learning of the weighting unit 51 and the recognizer 52 based on an input label series 33 and the abnormality degree output by the recognizer 52, and generates weighting unit parameters P3 and recognizer parameters P4.

(Learning Process)

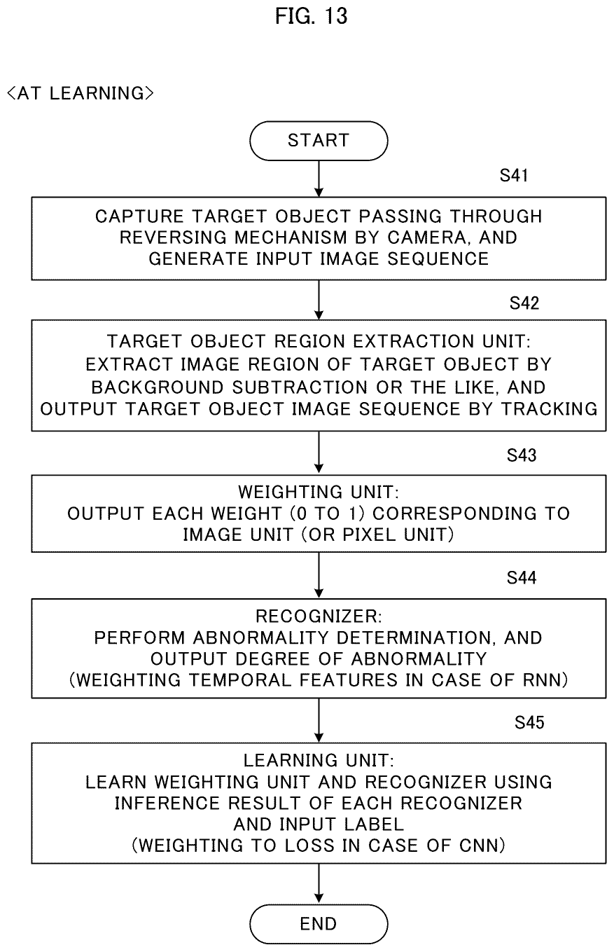

FIG. 13 is a flowchart of the learning process of the NN 50. This learning process is realized by executing a program prepared in advance by the processor 12 depicted in FIG. 2. First, the target object passing through the reversing mechanism is captured by the camera 4, and the input image sequence 31 is generated (step S41). Next, the target object region extraction unit 21 extracts an image region of the target object from the input image sequence 31 using the background subtraction or the like, and outputs the target object image sequence 32 by tracking (step S42).

Next, the weighting unit 51 outputs the weights by the image unit (or the pixel unit) for the target object image sequence 32 by using the pre-stage NN (step S43). Next, the recognizer 52 performs the inference by the post-stage NN described above (step S44). In a case where the NN 50 is the RNN, the recognizer 52 weights the temporal features using the weights output in step S43.

Next, the learning unit 53 performs the learning of the weighting unit 51 and the recognizer 52 using the inference result and the input label of the recognizer 52 to acquire the weighting unit parameters P3 and the recognizer parameters P4 (step S45). Note that in a case where the NN 50 is the CNN, the learning unit 53 weights a lost by using the weights output at step S43. After that, the learning process is terminated.

[At Inspection (at Inference)]

(Configuration at Inspection)

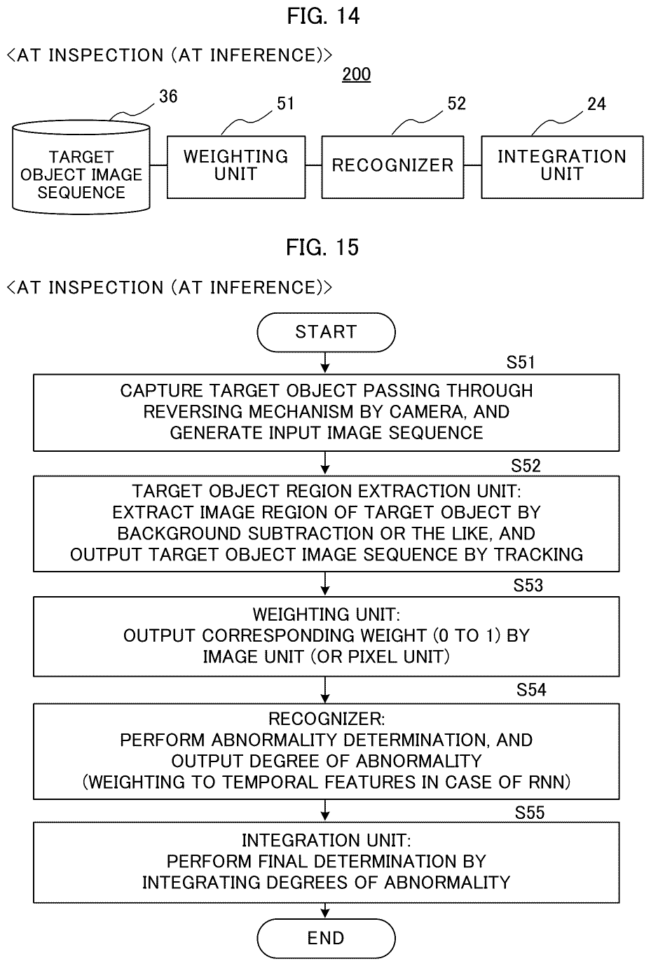

FIG. 14 illustrates a configuration at the inspection of the inspection device 200. At the inspection, the inspection device 200 includes the weighting unit 51, the recognizer 52, and the integration unit 24. The weighting unit 51 and the recognizer 52 is formed by the NN 50. The weighting unit parameters P3 acquired by the learning process are set to the weighting unit 51, and the recognizer parameters acquired by the learning process is set to the recognizer 52.

The target object image sequence 36 formed by the images acquired by taking the actual inspection object is input to the weighing unit 51. The weighting unit 51 generates weights by the image unit (or the pixel unit) based on the target object image sequence, and outputs the weights to the recognizer 52. The recognizer 52 performs the abnormality determination using the target object image sequence 32 and the weights, and outputs each degree of abnormality as the determination result to the integration unit 24. The integration unit 24 integrates the degree of abnormality being input, and outputs a final determination result.

(Inspection Process)

FIG. 15 is a flowchart of the inspection process by the inspection device 200. This inspection process is realized by executing a program prepared in advance by the processor 12 depicted in FIG. 2. First, the target object passing through the reversing mechanism is captured by the camera 4, and an input image sequence is generated (step S51). This input image sequence is an image acquired by capturing an actual inspection object. Next, the target object region extraction unit 21 extracts an image region of the target object from the input image sequence by using the background subtraction or the like, and outputs the target object image sequence 36 by tracing the target object (step S52).

Next, the weighting unit 51 outputs weights by the image units (or the pixel unit) of the target object image sequence 36 (step S53). Next, the recognizer 52 performs the abnormality determination of the target object image sequence 36 (step S54). In a case where the NN 50 is the RNN, the recognizer 52 weights temporal features with the weights output in step S53. Subsequently, the integration unit 24 performs a final determination by integrating the degree of abnormality output by the recognizer 52 (step S55). After that, the process is terminated.

As described above, in the second example embodiment, the group discrimination unit and the recognizer are formed by the NN and are simultaneously and consistently learned. In detail, the group description unit is formed by the pre-stage NN, and the recognizer is formed by the post-stage NN. Therefore, it is possible to perform the group discrimination by the pre-stage NN and perform the abnormality determination with a different parameter set for the post-stage NN, as a plurality of recognition models functionally are used.

### Third Example Embodiment

FIG. 16 is a block diagram illustrating a functional configuration of a learning device according to a third example embodiment. The learning device 60 includes an acquisition means 61 and a learning means 62.

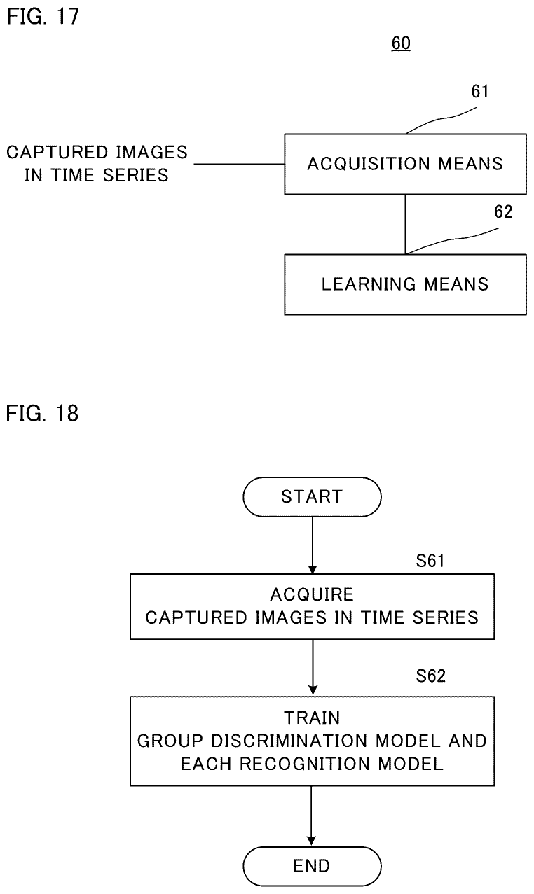

FIG. 17 is a flowchart of a process performed by the learning device 60. First, the acquisition means 61 acquires captured images in a time series which are acquired by capturing a target object (step S61). Next, the learning means 62 simultaneously trains a group discrimination model for discriminating a plurality of groups from the captured images and a plurality of recognition models for recognizing the captured images belonging to each group, based on features in each image (step S62).

### Fourth Example Embodiment

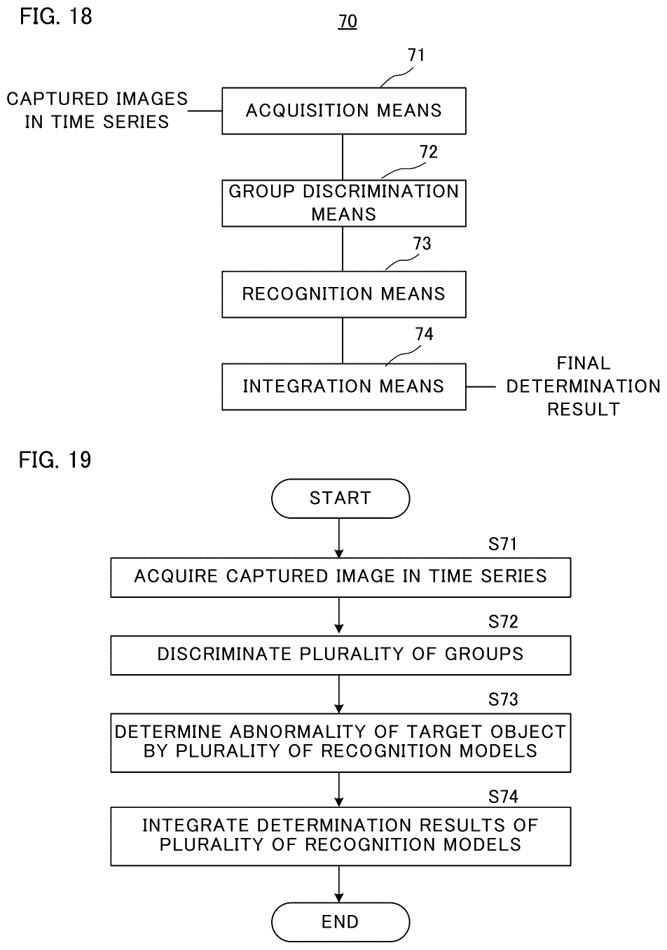

FIG. 18 is a block diagram illustrating a functional configuration of an inspection device according to a fourth example embodiment. The inspection device 70 includes an acquisition means 71, a group discrimination means 72, a recognition means 73, and an integration means 74.

FIG. 19 is a flowchart of a process performed by the inspection device 70. First, the acquisition means 71 acquires captured images of a time series which are acquired by capturing a target object (step S71). Next, the group discrimination means 72 uses a group discrimination model to discriminate a plurality of groups from captured images based on features in each of the images (step S72). Next, the recognition unit 73 recognizes the captured images belonging to the respective groups, and determines an abnormality of the target object using the plurality of recognition models (step S73). The group discrimination model and the plurality of recognition models are trained at the same time. The integration unit 74 integrates determination results of the plurality of recognition models and outputs a final determination result (step S74).

A part or all of the example embodiments described above may also be described as the following supplementary notes, but not limited thereto.

(Supplementary Note 1)

A learning device comprising:
an acquisition means configured to acquire captured images in a time series which capture a target object; and
a learning means configured to simultaneously train a group discrimination model for discriminating a plurality of groups from the captured images based on features in each image and the plurality of recognition models each for recognizing captured images belonging to a corresponding group.

(Supplementary Note 2)

The learning device according to supplementary note 1, wherein the learning means alternately repeats training of the group discrimination model and training of the recognition models.

(Supplementary Note 3)

The learning device according to supplementary note 2, wherein the learning means increase a number of the recognition models in a case where inference results by the recognition models include an incorrect answer.

(Supplementary Note 4)

The learning device according to supplementary note 2 or 3, wherein the learning means terminates in any of a case in which a number of iterations of the training of the group discrimination model and the training of the recognition models reaches a predetermined number, a case in which accuracy of the recognition models reaches a predetermined accuracy, and a case wherein a range of improvement in the accuracy of the recognition models is lower than or equal to a predetermined threshold.

(Supplementary Note 5)

The learning device according to any one of supplementary notes 1 to 4, wherein the recognition models determine an abnormality of the target object included in the captured images.

(Supplementary Note 6)

The learning device according to supplementary note 1, wherein
the learning means trains one NN including a pre-stage NN and a post-stage NN, and
the group discrimination model is formed by the pre-stage NN and the plurality of recognition models are formed by the post-stage NN.

(Supplementary Note 7)

The learning device according to supplementary note 6, wherein
the pre-stage NN outputs weights indicating a result of discrimination for the groups, and
the post-stage NN outputs a degree of abnormality of the target object included in the captured images based on the captured images and the weights.

(Supplementary Note 8)

A learning method comprising:
acquiring captured images in a time series which capture a target object; and
simultaneously training a group discrimination model for discriminating a plurality of groups from the captured images based on features in each image and the plurality of recognition models each for recognizing captured images belonging to a corresponding group.

(Supplementary Note 9)

A recording medium storing a program, the program causing a computer to perform a process comprising:
acquiring captured images in a time series which capture a target object; and
simultaneously training a group discrimination model for discriminating a plurality of groups from the captured images based on features in each image and the plurality of recognition models each for recognizing captured images belonging to a corresponding group.

(Supplementary Note 10)

An inspection device comprising:
an acquisition means configured to acquire captured images in a time series which capture a target object;
a group discrimination means configured to discriminate a plurality of groups from the captured images based on features in each image;
a recognition means configured to recognize the captured images belonging to each of the groups and determine an abnormality of the target object, by using the plurality of recognition models; and
an integration means configured to integrate determination results of the plurality of recognition models and output a final determination result,
wherein the group discrimination model and the plurality recognition models are simultaneously trained.

(Supplementary Note 11)

An inspection method comprising:
acquiring captured images in a time series which capture a target object;
discriminating a plurality of groups from the captured images based on features in each image;
recognizing the captured images belonging to each of the groups and determining an abnormality of the target object, by using the plurality of recognition models; and
integrating determination results of the plurality of recognition models and outputting a final determination result,
wherein the group discrimination model and the plurality recognition models are simultaneously trained.

(Supplementary Note 12)

A recording medium storing a program, the program causing a computer to perform a process comprising:
acquiring captured images in a time series which capture a target object;
discriminating a plurality of groups from the captured images based on features in each image;
recognizing the captured images belonging to each of the groups and determining an abnormality of the target object, by using the plurality of recognition models; and
integrating determination results of the plurality of recognition models and outputting a final determination result,
wherein the group discrimination model and the plurality recognition models are simultaneously trained.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

4 High-speed camera
5 Tablet
7 Reversing mechanism
12 Processor
21 Target object region extraction unit
22 Group discrimination unit
23 Recognizer
24 Integration unit
41 Recognizer learning unit
42 Group learning unit
50 Neural Network (NN)
51 Weighting unit
52 Recognizer
53 Learning unit
100, 200 Inspection device

What is claimed is:

1. A learning device comprising:
a memory storing instructions; and
one or more processors configured to execute the instructions to:
acquire captured images in a time series which capture a target object; and
simultaneously train a group discrimination model for discriminating a plurality of groups from the captured images based on features in each image and a plurality of recognition models each for recognizing captured images belonging to a corresponding group.

2. The learning device according to claim 1, wherein the processor alternately repeats training of the group discrimination model and training of the recognition models.

3. The learning device according to claim 2, wherein the processor increase a number of the recognition models in a case where inference results by the recognition models include an incorrect answer.

4. The learning device according to claim 2, wherein the processor terminates in any of a case in which a number of iterations of the training of the group discrimination model and the training of the recognition models reaches a predetermined number, a case in which accuracy of the recognition models reaches a predetermined accuracy, and a case wherein a range of improvement in the accuracy of the recognition models is lower than or equal to a predetermined threshold.

5. The learning device according to claim 1, wherein the recognition models determine an abnormality of the target object included in the captured images.

6. The learning device according to claim 1, wherein
the processor trains one NN including a pre-stage NN and a post-stage NN, and
the group discrimination model is formed by the pre-stage NN and the plurality of recognition models are formed by the post-stage NN.

7. The learning device according to claim 6, wherein
the pre-stage NN outputs weights indicating a result of discrimination for the groups, and
the post-stage NN outputs a degree of abnormality of the target object included in the captured images based on the captured images and the weights.

8. A learning method comprising:
acquiring captured images in a time series which capture a target object; and
simultaneously training a group discrimination model for discriminating a plurality of groups from the captured images based on features in each image and a plurality of recognition models each for recognizing captured images belonging to a corresponding group.

9. A non-transitory computer-readable recording medium storing a program, the program causing a computer to perform the learning method according to claim 12.

10. An inspection device comprising:
a memory storing instructions; and
one or more processors configured to execute the instructions to:
acquire captured images in a time series which capture a target object;
discriminate a plurality of groups from the captured images based on features in each image;
recognize the captured images belonging to each of the groups and determine an abnormality of the target object, by using a plurality of recognition models; and
integrate determination results of the plurality of recognition models and output a final determination result,
wherein the group discrimination model and the plurality recognition models are simultaneously trained.

11. An inspection method performed by the inspection device according to claim 10.

12. A non-transitory computer-readable recording medium storing a program, the program causing a computer to perform the inspection method according to claim 11.
